(19) United States
(12) Patent Application Publication
(10) Pub. No.: US 2017/0044356 A1
(43) Pub. Date: Feb. 16, 2017

(54) COMPOSITE MATERIAL COMPRISING ETHYLENE/PROPYLENE COPOLYMER AND METHOD FOR PREPARING THE SAME

(71) Applicant: GUANG ZHOU LEVEL LIGHTING CO., LTD, Guangzhou (CN)

(72) Inventor: Xukai YANG, Guangzhou (CN)

(21) Appl. No.: 15/235,133

(22) Filed: Aug. 12, 2016

(30) Foreign Application Priority Data
Aug. 12, 2015 (CN) 201510492458.8

(51) Int. Cl. C08L 23/06; C08J 5/10; C08J 3/12; C08J 5/00; C08L 23/12; C08L 23/16

(52) U.S. Cl. CPC C08L 23/06; C08L 23/12; C08L 23/16; C08J 3/12; C08J 5/005; C08J 5/10; C08L 2201/08; C08L 2205/06; C08L 2205/02; C08J 2323/06; C08J 2323/12; C08J 2323/16

(57) ABSTRACT

A composite material, including between 30 and 94 percent by weight of a polymer mixture of polyethylene or polypropylene, polyolefin elastomer, and sorbitol; between 5 and 60 percent by weight of a reinforcing agent; between 0 and 40 percent by weight of a strengthening agent; between 0.1 and 1 percent by weight of a disproportionation agent; between 0.1 and 1 percent by weight of a coupling agent; between 0.1 and 1 percent by weight of an antioxidant; between 0.1 and 1 percent by weight of an anti-aging agent; between 0.1 and 1 percent by weight of an ultraviolet absorber; between 0.1 and 1 percent by weight of a lubricant; and between 0.1 and 1 percent by weight of triethyl aluminum. A method for preparing the composite material includes separately mixing components, combining them in a twin screw extruder, and extruding and granulating the combined mixture.

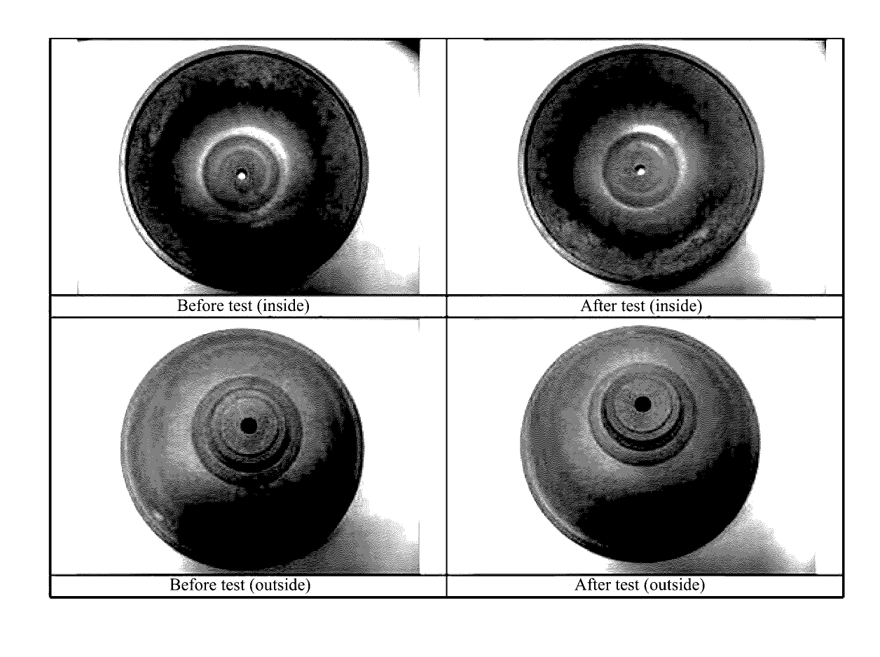

### CROSS-REFERENCE TO RELATED APPLICATIONS

Pursuant to 35 U.S.C. §119 and the Paris Convention Treaty, this application claims the benefit of Chinese Patent Application No. 201510492458.8 filed Aug. 12, 2015, the contents of which are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, and Cambridge, Mass. 02142.

### BACKGROUND OF THE INVENTION

Field of the Invention

The invention relates to the field of composite materials, and more particularly to a composite material comprising ethylene/propylene copolymer and a method for preparing the same.

Description of the Related Art

Typically, resin materials are made of either polyethylene or polypropylene. However, such materials are not fireproof, tend to deform, and have low strength, low surface tension, and poor paint adhesibility.

### SUMMARY OF THE INVENTION

In view of the above-described problems, it is one objective of the invention to provide a composite material which has high strength, strong toughness, and good paint adhesibility. The composite material is fireproof and resistant to deformation.

It is another objective of the invention to provide a method for preparing the composite material.

To achieve the above objective, in accordance with one embodiment of the invention, there is provided a composite material, comprising:

between 30 and 94 percent by weight of a polymer mixture; the polymer mixture comprising between 69 and 95 percent by weight of polyethylene or polypropylene, between 4 and 30 percent by weight of polyolefin elastomer (POE), and between 0.3 and 1 percent by weight of sorbitol as a rigidity enhancer;

between 5 and 60 percent by weight of a reinforcing agent;

between 0 and 40 percent by weight of a strengthening agent;

between 0.1 and 1 percent by weight of a disproportionation agent, the disproportionation agent being pentaerythritol tetrakis(3-(3,5-di-tert-butyl-4-hydroxyphenyl)propionate);

between 0.1 and 1 percent by weight of a coupling agent;

between 0.1 and 1 percent by weight of an antioxidant;

between 0.1 and 1 percent by weight of an anti-aging agent;

between 0.1 and 1 percent by weight of an ultraviolet absorber;

between 0.1 and 1 percent by weight of a lubricant; and

between 0.1 and 1 percent by weight of triethyl aluminum.

The POE is an abbreviation of polyolefin elastomer. The polyolefin elastomer is polyolefin thermoplastic elastomer: ethylene-octylene copolymer, synthesized using metallocene as a catalyst.

In a class of this embodiment, the polyethylene has a density range of 0.91-0.94 g/cm³ or of 0.93-0.97 g/cm³.

In a class of this embodiment, the sorbitol as a rigidity enhancer are dibenzylidene sorbitol.

In a class of this embodiment, the reinforcing agent is nanoscale mineral powders. The reinforcing agent is nanoscale talcum powders, nanoscale calcium-silica powders, nanoscale calcium carbonate, nanoscale marble powders, nanoscale barium sulfate, or a mixture thereof.

In a class of this embodiment, the strengthening agent is a reinforced fiber, preferably, the strengthening agent is a glass fiber experiencing twice drawings.

Preferably, the antioxidant is antioxidant KY790, heterogenic antioxidant 1010, or a mixture thereof.

Preferably, the anti-aging agent is anti-aging agent 100H.

In a class of this embodiment, the ultraviolet absorber is ultraviolet absorber UV531. Preferably, the coupling agent is a silane coupling agent, or the coupling agent is a modified silane coupling agent. A method for preparing the modified silane coupling agent comprises:

1) stirring isopropanol under normal pressure at a temperature of between 83° C. and 86° C., and adding a silane coupling agent to the isopropanol, wherein a weight percentage of the isopropanol is between 75% and 85%, and a weight percentage of the silane coupling agent is between 15% and 25%; allowing the isopropanol and the silane coupling agent to react for 25 and 40 min to yield a modified silane coupling agent of which part of methoxy groups being replaced by isopropoxy groups; and

2) stirring the modified silane coupling agent under normal pressure at a temperature of between 58° C. and 63° C., and adding octamethylcyclotetrasiloxane and acrylic monomers (such as methyl acrylate, ethyl acrylate, N-butyl acrylate, isobutyl acrylate, 2-ethyl hexyl acrylate, and 2-hydroxypropyl acrylate) to the modified silane coupling agent, wherein a weight percentage of the modified silane coupling agent is between 85% and 95%, and weight percentages of the octamethylcyclotetrasiloxane and the acrylic monomers are both between 2.5% and 7.5%; performing an emulsion polymerization to yield the modified silane coupling agent.

Preferably, the coupling agent is the silane coupling agent, or the coupling agent is a modified silane coupling agent A. A method for preparing the modified silane coupling agent A comprises:

1) stirring isopropanol under normal pressure at a temperature of 85° C., and adding a silane coupling agent KH-570 in the isopropanol, where a weight percentage of the isopropanol is 80%, and a weight percentage of the silane coupling agent KH-570 is 20%; allowing the isopropanol and the silane coupling agent to react for 30 min to yield a modified KH-570 of which part of methoxy groups being replaced by isopropoxy groups;

2) stirring the modified KH-570 under normal pressure at a temperature of 60° C., and adding octamethylcyclotetrasiloxane and acrylic monomers in the modified KH-570, where a weight percentage of the modified KH-570 is 90%, and weight percentages of the octamethylcyclotetrasiloxane and the acrylic monomers are both 5%; performing an emulsion polymerization to yield the modified silane coupling agent A.

In a class of this embodiment, the lubricant is microcrystalline wax lubricant E. A method for preparing the microcrystalline wax lubricant E comprises: completely melting 500 g of microcrystalline wax in a thermostat; continuously stirring the microcrystalline wax and adding a mixture comprising 175 mL of water and between 30 and 40 g of anionic emulsifier to the microcrystalline wax; adding between 15 and 30 g of nonionic emulsifier to the mixture to form a homogeneous body; stopping stirring, and obtaining the microcrystalline wax lubricant; a reaction temperature in the preparation process is maintained at between 110° C. and 115° C. The anionic emulsifier is sodium dodecyl sulfate. Optionally, the nonionic emulsifier is tween 80. The stirring speed is between 800 and 1200 rpm.

A method for preparing the composite material, comprising:

1) adding and stirring the reinforcing agent in a mixer at a constant temperature of between 70° C. and 90° C.; adding the coupling agent; uniformly mixing the reinforcing agent with the coupling agent to yield a first reaction mixture;

2) adding and uniformly mixing the polymer mixture, the disproportionation agent, the antioxidant, the anti-aging agent, the ultraviolet absorber, the lubricant, and the triethyl aluminum in the mixer at room temperature to yield a second reaction mixture; and

3) adding the first reaction mixture and the second reaction mixture to a twin screw extruder; adding the strengthening agent to the twin screw extruder to form a third reaction mixture; extruding and granulating the third reaction mixture to form a granular composite material.

A temperature of the twin screw extruder is between 180° C. and 215° C., and a rotational speed of a screw rod of the twin screw extruder is between 370 and 400 rpm.

Advantages of the composite material and the method for preparing the same according to embodiments of the invention are summarized as follows. The composite material features moderate formula, low cost, high strength, strong toughness, and good paint adhesion. The composite material is fireproof and has less possibility of deforming. The method features simple process and is convenient to operate.

### BRIEF DESCRIPTION OF THE DRAWINGS

The invention is described hereinbelow with reference to accompanying drawings, in which the sole FIGURE is a diagram showing a comparison before and after a high-temperature resistance test of a lamp base made from a composite material of an exemplary embodiment of the invention.

### DETAILED DESCRIPTION OF THE EMBODIMENTS

For further illustrating the invention, experiments detailing a composite material and a method for preparing the same are described below. It should be noted that the following examples are intended to describe and not to limit the invention.

### EXAMPLE 1

A composite material comprises:

between 30 and 94 percent by weight of a polymer mixture; the polymer mixture comprising between 69 and 95 percent by weight of polyethylene or polypropylene, between 4 and 30 percent by weight of polyolefin elastomer (POE), and between 0.3 and 1 percent by weight of sorbitol as a rigidity enhancer;

between 5 and 60 percent by weight of a reinforcing agent;

between 0 and 40 percent by weight of a strengthening agent;

between 0.1 and 1 percent by weight of a disproportionation agent, the disproportionation agent being pentaerythritol tetrakis(3-(3,5-di-tert-butyl-4-hydroxyphenyl)propionate);

between 0.1 and 1 percent by weight of a coupling agent;

between 0.1 and 1 percent by weight of an antioxidant;

between 0.1 and 1 percent by weight of an anti-aging agent;

between 0.1 and 1 percent by weight of an ultraviolet absorber;

between 0.1 and 1 percent by weight of a lubricant; and

between 0.1 and 1 percent by weight of triethyl aluminum.

A ratio of the polyethylene or the polypropylene to the POE and the sorbitol as a rigidity enhancer is 69%:30%:1%, 95%:4%:1%, 95%:4.7%:0.3%, 80%:19%:1%, or 75%:24.5%:0.5%.

Optionally, the polyethylene is high-density polyethylene having a density range of 0.93-0.97 g/cm³, and the composite material prepared using the high-density polyethylene features high hardness; or the polyethylene is low-density polyethylene having a density range of 0.91-0.94 g/cm³, and the composite material prepared using the low-density polyethylene features strong toughness.

Preferably, the polypropylene is prepared using a method of liquid-phase bulk polymerization: performing a liquid bulk polymerization of liquid-phase propylene monomers in a reaction still, and performing a gas phase copolymerization of ethylene and propylene in a fluidized bed reactor. Compared with other polypropylene, the polypropylene prepared using the method of liquid-phase bulk polymerization features high purity, and the composite material prepared using the polypropylene features better mechanical properties.

The sorbitol as a rigidity enhancer are benzylidene sorbitol compounds, such as dibenzylidene sorbitol, and di-(3,4-dimethylbenzylidene) sorbitol. The sorbitol as a rigidity enhancer are added to improve the rigidity and hardness of the composite material, so that the composite material can be applied to both indoor and outdoor environments.

The reinforcing agent is mineral powders, such as talcum powders, calcium-silica powders, calcium carbonate, marble powders, and barium sulfate. Preferably, the mineral powders are nanoscale. On the one hand, the barium sulfate can reinforce the composite material, on the other hand, the barium sulfate is heavy in weight, thus the composite material containing barium sulfate is also heavy in weight. The lamp fittings using composite material containing the reinforcing agent feature metallic texture, and when the lamp fittings are painted according to needs, a painting is just like the painting on metal.

The strengthening agent is a reinforced fiber, preferably, the strengthening agent is a glass fiber experiencing twice drawings so as to obviously improve the strength of the composite material.

Preferably, the antioxidant is antioxidant KY790, heterogenic antioxidant 1010, or a mixture thereof.

Preferably, the anti-aging agent is anti-aging agent 100H.

The ultraviolet absorber is ultraviolet absorber UV531.

The coupling agent is a conventional silane coupling agent, or preferably, the coupling agent is a modified silane coupling agent A. A method for preparing the modified silane coupling agent comprises A:

1) stirring isopropanol under normal pressure at a temperature of between 83° C. and 86° C., and adding a silane coupling agent KH-570 in the isopropanol, where a weight percentage of the isopropanol is between 75% and 85%, and a weight percentage of the silane coupling agent KH-570 is between 15% and 25%; allowing the isopropanol and the silane coupling agent to react for 25 and 40 min to yield a modified KH-570 having isopropoxy groups as a substitution for a part of methoxy groups;

2) stirring the modified KH-570 under normal pressure at a constant temperature of between 58° C. and 63° C., and adding octamethylcyclotetrasiloxane and acrylic monomers in the modified KH-570, where a weight percentage of the modified KH-570 is between 85% and 95%, and weight percentages of the octamethylcyclotetrasiloxane and the acrylic monomers are both between 2.5% and 7.5%; performing an emulsion polymerization to yield the modified silane coupling agent A.

On the one hand, the modified silane coupling agent A is added to the composite material to improve the acid and alkali resistance and toughness of the composite material without adding any toughening agent so that the composite material can be used as a substitution for metal materials and be applied to the outdoor environment. On the other hand, the molding time of the composite material is shortened, and the production efficiency is improved.

The lubricant is conventional microcrystalline wax lubricant, preferably, the lubricant is microcrystalline wax lubricant E. A method for preparing the microcrystalline wax lubricant E comprises: melting 500 g of microcrystalline wax in a thermostat so that the microcrystalline wax is completely melted and flows freely; then continuously stirring the microcrystalline wax and adding 175 mL of water with between 30 and 40 g of dissolved anionic emulsifier in the microcrystalline wax; and adding between 15 and 30 g of nonionic emulsifier to form a homogeneous body; stopping stirring to yield the microcrystalline wax lubricant E. A reaction temperature is kept between 110° C. and 115° C. The anionic emulsifier is sodium dodecyl sulfate. Optionally, the nonionic emulsifier is tween 80. The stirring speed is between 800 and 1200 rpm. The microcrystalline wax lubricant E containing the anionic emulsifier and the nonionic emulsifier is applied to the composite material, enabling interactions with polar structures and non-polar structures in other materials, thus the microcrystalline wax lubricant E can lubricate the composite material.

A composite material in the invention can be widely applied to outdoor and indoor structural components, such as the fixed base and the external shield of lamp.

### EXAMPLE 2

A method for preparing the composite material using the materials having the weight percentages in Example 1, comprises:

1) heating a mixer to a constant temperature of between 70° C. and 90° C.; adding and stirring the reinforcing agent; and adding the coupling agent; uniformly mixing the reinforcing agent with the coupling agent to yield and discharge a first reaction mixture; when the stirring speed is at 500 rpm, the reinforcing agent and the coupling agent are stirred for 5 min so that the reinforcing agent and the coupling agent are uniformly mixed;

2) adding and uniformly mixing the polymer mixture, the disproportionation agent, the antioxidant, the anti-aging agent, the ultraviolet absorber, the lubricant, and the triethyl aluminum in the mixer at room temperature to yield a second reaction mixture; discharging the second reaction mixture; when the stirring speed is at 500 rpm, the materials in 2) are stirred for 5 min so that the materials are uniformly mixed;

3) adding the first reaction mixture in 1) and the second reaction mixture in 2) in a twin screw extruder; adding the strengthening agent from a side direction of the twin screw extruder to form a third reaction mixture; extruding and granulating the third reaction mixture to form a granular composite material.

A temperature of the twin screw extruder is between 180° C. and 215° C., and a rotational speed of a screw rod of the twin screw extruder is between 370 and 400 rpm.

The reinforcing agent and the coupling agent are mixed in advance so that the reinforcing agent is uniformly dispersed in the composite material, and the strength of the composite material is improved.

### EXAMPLE 3

In the example, the composite material in Example 1 is prepared using the method in Example 2, and specifically, the materials of the composite material have the following groups of weight percentages, as shown in Table 1:

TABLE 1

| | Groups | | | | | | | | |
|---|---|---|---|---|---|---|---|---|---|
| Materials | 1 | 2 | 3 | 4 | 5 | 6 | 7 | 8 | 9 |
| Polymer mixture comprising polyethylene/(%) | 30 | 52 | 70 | 94 | 0 | 0 | 0 | 0 | 0 |
| Polymer mixture comprising polypropylene/(%) | 0 | 0 | 0 | 0 | 30 | 40 | 65 | 70 | 94 |
| Reinforcing agent/(%) | 60 | 5 | 19.3 | 5 | 60 | 17 | 10 | 20 | 5 |
| Strengthening agent/(%) | 3 | 40 | 10 | 0 | 3 | 40 | 24 | 6 | 0 |
| Disproportionation agent/(%) | 1 | 0.4 | 0.1 | 0.2 | 1 | 0.4 | 0.1 | 1 | 0.1 |
| Coupling agent/(%) | 1 | 0.4 | 0.1 | 0.2 | 1 | 0.4 | 0.1 | 1 | 0.1 |
| Antioxidant/(%) | 1 | 0.4 | 0.1 | 0.1 | 1 | 0.4 | 0.1 | 1 | 0.6 |
| Anti-aging agent/(%) | 1 | 0.4 | 0.1 | 0.1 | 1 | 0.4 | 0.1 | 0.3 | 0.1 |
| Ultraviolet absorber/(%) | 1 | 0.5 | 0.1 | 0.1 | 1 | 0.5 | 0.1 | 0.1 | 0.1 |
| Lubricant/(%) | 1 | 0.4 | 0.1 | 0.1 | 1 | 0.4 | 0.1 | 0.4 | 0.1 |
| Triethyl aluminum/(%) | 1 | 0.5 | 0.1 | 0.2 | 1 | 0.5 | 0.1 | 0.2 | 0.1 |

In Groups 1-4, the polymer mixture is prepared using polyethylene, polyolefin elastomer (POE), and sorbitol as a rigidity enhancer, thus the preparation of the composite material involves ethylene polymers. In Groups 5-9, the polymer mixture is prepared using polypropylene, POE, and sorbitol as a rigidity enhancer, thus the preparation of the composite material involves propylene polymers.

### EXAMPLE 4

The results prepared in Example 3 are tested in the example:

(1) Impact Strength

According to the ASTM D256 Standard test, the notched impact strength of the composite material is more than 22 KJ/m², indicating that the composite material features good impact resistance.

(2) Bending Strength

According to the ASTM D790 Standard test, the bending strength of the composite material is more than 65 megapascal, indicating the composite material features high rigidity and hardness.

(3) High-Temperature Resistance

A lamp base is made from the composite material and undergoes the high-temperature resistance test: the lamp base is rested at 120° C. for 24 hrs. A comparison before and after the high-temperature resistance test of the lamp base is shown in the FIGURE, from the FIGURE, the inner and outer surfaces of the lamp base after the high-temperature resistance test show no obvious variation, indicating the composite material features favorable high-temperature resistance.

(4) Anti-Ultraviolet and Anti-Aging Performance

A fixing plate of lamp is made from composite material and undergoes the anti-ultraviolet and anti-aging performance test according to the ASTM G154-06, ISO 105-A02: 1993/Cor 2: 2005:

Type of lamp: D65 standard lamp

Exposure cycle: ASTM G154 cycle 18 h UV at (60±3)° C. BPT,0.89W/(m²·nm)@340 nm 4 h condensation at (50±3)° C. BPT

Exposure duration: 500 hrs

Considering that the D65 standard lamp is the test lamp, the grey value 5 represents the best anti-ultraviolet and anti-aging performance, and the grey value 1 represents the worst performance. The grey value of the fixing plate of lamp made from the composite material in the invention is between 4 and 5, indicating that the composite material features favorable anti-ultraviolet and anti-aging performance.

(5) Adhesion

A fixing plate of lamp is made from composite material and undergoes the adhesion test according to the ASTM D 3359-09 method A:

Test condition:

Tape: Permacel 99

Considering that the fixing plate of lamp is tested using the ASTM D 3359-09 method A, the adhesion force 5A represents the best adhesion, and the adhesion force 0A represents the worst. The adhesion force of the fixing plate of lamp made from composite material in the invention is 4A, indicating that the composite material features good adhesion, and is easy to be painted.

(6) Weather Resistance

A fixing plate of lamp is made from composite material and undergoes the salt spray test according to the ASTM B117-07a:

Test conditions:

Concentration of solution: (5±1)% NaCl(m/m)

Room temperature: (35±2)° C.

Volume of salt solution: (1.0-2.0) ml/(80 cm²·h)

pH value when the solution is at 25° C.: 6.5-7.2

Test duration: 500 hrs

The appearance grade of the fixing plate of lamp is tested to be 10, which is the highest grade of appearance, indicating that the composite material features good salt spray resistance and good weather resistance, thus the composite material can be applied to outdoor, indoor, and even seaside environment, and the composite material can be used as the material of structural components such as desk, chair, advertisement frame, and lamp.

(7) Durability, Impact Resistance, and Air Tightness Tests

The test results are shown in Table 2:

TABLE 2

Intervals

| Performance | Set values (s) | Measured values (s) |
|---|---|---|
| Durability | 30 | 29.91 |
| | 60 | 59.92 |
| | 90 | 89.92 |
| Impact resistance | 30 | 29.92 |
| | 60 | 59.91 |
| | 90 | 89.90 |
| Air tightness | 30 | 29.90 |
| | 60 | 59.88 |
| | 90 | 89.92 |

As shown in Table 2, the composite material features favorable durability, impact resistance, and air tightness. The composite material has long service life and can be used as a substitution for metal materials. In addition, the composite material can be employed to insulate or package the structural components.

(8) Electrical Breakdown Strength

According to the ASTM D149 Standard test, the electrical breakdown strength of the composite material is more than 20 KV/mm, indicating that the composite material features good electrical resistance, is safe to use, and is applicable for charged structural components and outdoor environment.

(9) Volume Resistivity

According to the ASTM D257 Standard test, the volume resistivity of the composite material is more than 1016 Ωcm, indicating that the composite material features favorable electrical insulating property, is safe to use, and is applicable for charged structural components (such as fixing device, shield, and decorative cover of lamp) and outdoor environment.

Unless otherwise indicated, the numerical ranges involved in the invention include the end values. While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A composite material, comprising, based on a total weight of the entire composite material:
between 30 and 94 percent by weight of a polymer mixture; the polymer mixture comprising between 69 and 95 percent by weight of polyethylene or polypropylene, between 4 and 30 percent by weight of polyolefin elastomer (POE), and between 0.3 and 1 percent by weight of sorbitol as a rigidity enhancer;
between 5 and 60 percent by weight of a reinforcing agent;
between 0 and 40 percent by weight of a strengthening agent;
between 0.1 and 1 percent by weight of a disproportionation agent, the disproportionation agent being pentaerythritol tetrakis(3-(3,5-di-tert-butyl-4-hydroxyphenyl)propionate);
between 0.1 and 1 percent by weight of a coupling agent;
between 0.1 and 1 percent by weight of an antioxidant;
between 0.1 and 1 percent by weight of an anti-aging agent;
between 0.1 and 1 percent by weight of an ultraviolet absorber;
between 0.1 and 1 percent by weight of a lubricant; and
between 0.1 and 1 percent by weight of triethyl aluminum.

2. The material of claim 1, wherein the polyethylene has a density range of 0.91-0.94 g/cm³ or of 0.93-0.97 g/cm³.

3. The material of claim 1, wherein the sorbitol is dibenzylidene sorbitol.

4. The material of claim 1, wherein the reinforcing agent is nanoscale mineral powders; the strengthening agent is a reinforced fiber.

5. The material of claim 4, wherein the reinforcing agent is nanoscale talcum powders, nanoscale calcium-silica powders, nanoscale calcium carbonate, nanoscale marble powders, nanoscale barium sulfate, or a mixture thereof; the strengthening agent is a glass fiber.

6. The material of claim 1, wherein the coupling agent is a silane coupling agent, or a modified silane coupling agent; a method for preparing the modified silane coupling agent comprises:
1) stirring isopropanol under normal pressure at a temperature of between 83° C. and 86° C., and adding a silane coupling agent to the isopropanol, wherein a weight percentage of the isopropanol is between 75% and 85%, and a weight percentage of the silane coupling agent is between 15% and 25%; allowing the isopropanol and the silane coupling agent to react for 25 and 40 min to yield a modified silane coupling agent of which part of methoxy groups being replaced by isopropoxy groups; and
2) stirring the modified silane coupling agent under normal pressure at a temperature of between 58° C. and 63° C., and adding octamethylcyclotetrasiloxane and acrylic monomers to the modified silane coupling agent, wherein a weight percentage of the modified silane coupling agent is between 85% and 95%, and weight percentages of the octamethylcyclotetrasiloxane and the acrylic monomers are both between 2.5% and 7.5%; performing an emulsion polymerization to yield the modified silane coupling agent.

7. The material of claim 1, wherein the lubricant is a microcrystalline wax lubricant;
a method for preparing the microcrystalline wax lubricant comprises: completely melting 500 g of microcrystalline wax in a thermostat; continuously stirring the microcrystalline wax and adding a mixture comprising 175 mL of water and between 30 and 40 g of anionic emulsifier to the microcrystalline wax; adding between 15 and 30 g of nonionic emulsifier to the mixture to form a homogeneous body; stopping stirring, and obtaining the microcrystalline wax lubricant; a reaction temperature in the preparation process is maintained at between 110° C. and 115° C.

8. The material of claim 7, wherein the anionic emulsifier is sodium dodecyl sulfate;
optionally, the nonionic emulsifier is tween 80; a speed of stirring is between 800 and 1200 rpm.

9. A method for preparing the composite material of claim 1, the method comprising:
1) adding and stirring the reinforcing agent in a mixer at a constant temperature of between 70° C. and 90° C.; adding the coupling agent; uniformly mixing the reinforcing agent with the coupling agent to yield a first reaction mixture;
2) adding and uniformly mixing the polymer mixture, the disproportionation agent, the antioxidant, the anti-aging agent, the ultraviolet absorber, the lubricant, and the triethyl aluminum in the mixer at room temperature to yield a second reaction mixture; and
3) adding the first reaction mixture and the second reaction mixture to a twin screw extruder; adding the strengthening agent to the twin screw extruder, controlling a temperature of the twin screw extruder to be between 180° C. and 215° C., and controlling a rotational speed of a screw rod of the twin screw extruder to be between 370 and 400 rpm, to form a third reaction mixture; extruding and granulating the third reaction mixture to form a granular composite material.
